(19) United States
(12) Patent Application Publication
(10) Pub. No.: US 2020/0217291 A1
(43) Pub. Date: Jul. 9, 2020

(54) POWER GENERATION DEVICE UTILIZING SEAWATER

(71) Applicant: CHUN-HUEI CHEN, Puli Township (TW)

(72) Inventor: CHUN-HUEI CHEN, Puli Township (TW)

(21) Appl. No.: 16/726,931

(22) Filed: Dec. 26, 2019

(30) Foreign Application Priority Data
Jan. 3, 2019 (TW) 108100227

(51) Int. Cl. F03B 7/00; H02K 7/18; F03B 13/08

(52) U.S. Cl. CPC F03B 7/00; F03B 13/08; H02K 7/18

(57) ABSTRACT

The power generation device includes a fourth tube having an input end below sea level, a third hydro power module having an input end connected to an output end of the fourth tube, a fifth tube having an input end connected to an output end of the third hydro power module, an output end disposed above ground to expel seawater, and a number of step sections connected in between, and a number of flow guiding modules including first waterwheels, second waterwheels, hoist devices, motors, and transmission elements. The first waterwheels are configured along the fourth tube, the second waterwheels and the hoist devices are configured along the step sections, the motors are electrically connected to an external power source, and are connected to the hoist devices. The third hydro power module produces electricity as seawater flow through to power an external equipment or to be stored in a battery.

### BACKGROUND OF THE INVENTION

### (a) Technical Field of the Invention

The present invention is generally related to power generation, and more particular to a power generation device utilizing seawater.

### (b) Description of the Prior Art

As traditional energy resource is depleted, providing sufficient energy is a top priority for the development of modern nations.

Existing means for power generation, such as thermal or nuclear power generation usually would lead to environmental pollution.

For renewable energy resources such as hydro, solar, and wind power, hydro power is the most reliable and is easier to harness. However, usually a dam and a large-scale substation are required. Construction cost is high, and technology involved is complicated. River water also cannot be exploited during dry season. The abundant seawater, however, is rarely utilized in power generation.

### SUMMARY OF THE INVENTION

Therefore, the present invention teaches a power generation device utilizing seawater. The power generation device includes a fourth tube having an input end below sea level, a third hydro power module having an input end connected to an output end of the fourth tube, a fifth tube having an input end connected to an output end of the third hydro power module, an output end disposed above ground to expel seawater, and a number of step sections connected in between, and a number of flow guiding modules including first waterwheels, second waterwheels, hoist devices, motors, and transmission elements. The first waterwheels are configured along the fourth tube, the second waterwheels and the hoist devices are configured along the step sections, the motors are electrically connected to an external power source, and are connected to the hoist devices. The third hydro power module produces electricity as seawater flow through to power an external equipment or to be stored in a battery.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a seawater power generation device according to a first embodiment of the present invention.

FIG. 2 is a schematic diagram showing a seawater power generation device according to a second embodiment of the present invention.

FIG. 3 is a schematic diagram showing a seawater power generation device according to a third embodiment of the present invention.

FIG. 4 is a schematic diagram showing a scenario of the seawater power generation device of FIG. 3.

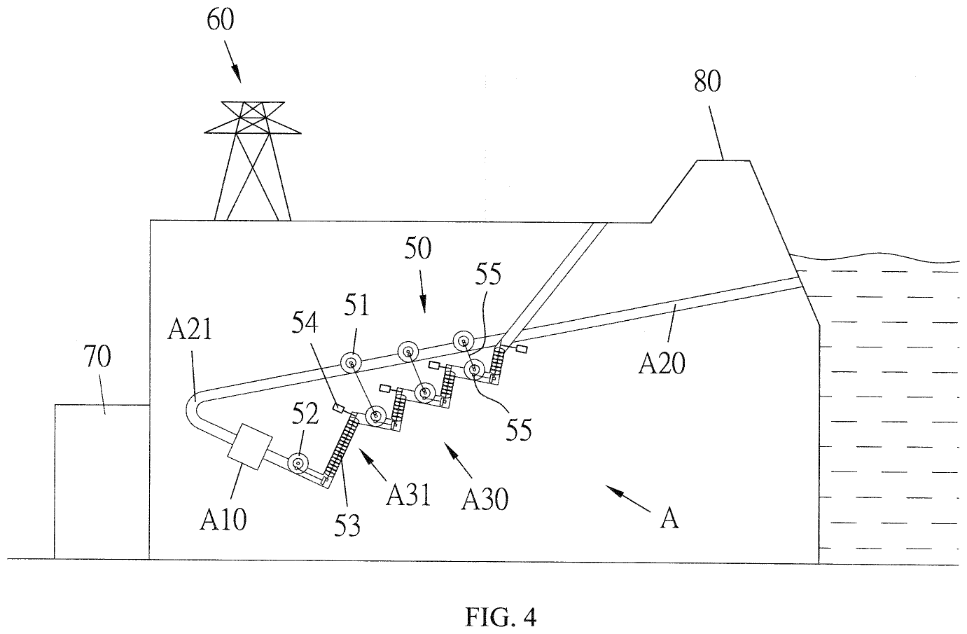

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

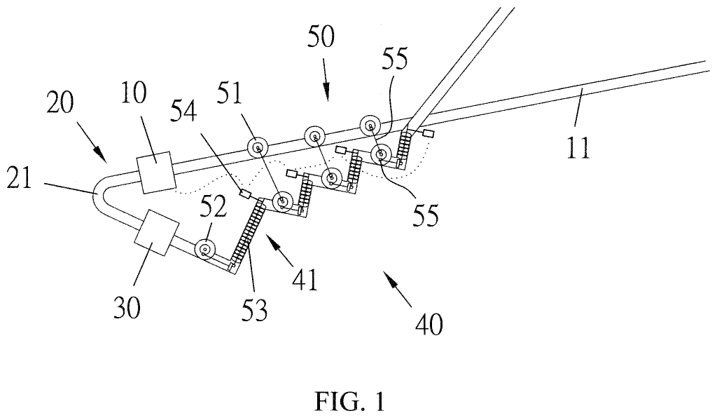

As shown in FIG. 1, a seawater power generation device according to a first embodiment of the present invention includes the following components.

At least a first hydro power module 10 is disposed underground. An input end of the first hydro power module 10 is connected to an output end of a first tube 11. An input end of the first tube 11 is disposed underground and is below sea level to facilitate the drawing of seawater.

At least a second tube 20 includes a V-shaped bended section 21 having a less than 90-degree angle between the V shape's two arms. An input end of the second tube 20 is connected to an output end of the first hydro power module 10.

At least a second hydro power module 30 is disposed underground. An input end of the second hydro power module 30 is connected to an output end of the second tube 20.

At least a third tube 40 has an input end connected to an output end of the second hydro power module 30. An output end of the third tube 40 is disposed above ground to expel seawater. The third tube 40 includes a number of L-shaped step sections 41 end-to-end sequentially connected in series between the third tube 40's input and output ends.

A number of flow guiding modules 50, includes first waterwheels 51, second waterwheels 52, hoist devices 53, motors 54, and transmission elements 55

The first waterwheels 51 are configured along the first tube 11. The second waterwheels 52 and the hoist devices 53 are configured along the step sections 41. The first hydro power modules 10 are respectively electrically connected to the motors 54. The motors 54 are connected to the hoist devices 53.

The first hydro power module 10 and the second hydro power module 30 produce electricity as seawater flow through them. The electricity from the first hydro power module 10 powers the motors 54 which in turn drive the hoist devices 53 to lift and expel seawater. The electricity from the second hydro power module 30 is used to power at least an external equipment (not shown) or is stored in at least a battery (not shown).

Each transmission element 55 is configured between a first waterwheel 51 and a second waterwheel 52. As the first waterwheels 5 lare engaged by seawater flowing through, the second waterwheels 52 are engaged as well through the transmission elements 55. The second waterwheels 52 respectively turn the hoist devices 53 to left seawater upward.

In other words, the hoist devices 53 are powered both by the kinetic energy of flowing seawater and the electricity produced from the first hydro power module 10 as seawater flowing through. Even though the third tube 40's output end is above the input end of the first tube 11, the above-described mechanism may still expel seawater onto the ground through the third tube 40.

In practical application, the first tube 11 may be integrated with an embankment (not shown), and a mesh (not shown) may be configured at the input end of the first tube 11 that is open to seawater.

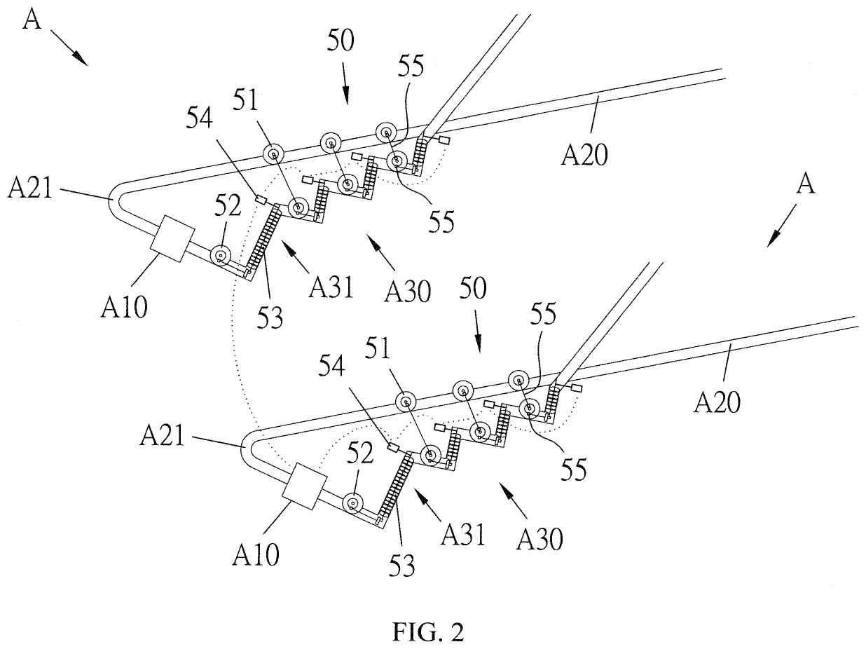

As shown in FIG. 2, a power generation device according to a second embodiment of the present invention includes an assembly A, which in turn includes at least a third power module A10. The third power module A10 is disposed underground, and has an input end connected to an output end of a fourth tube A20. An input end of the fourth tube A20 is disposed underground and is below sea level to facilitate the drawing of seawater. The fourth tube A20 includes a V-shaped bended section A21 having a less than 90-degree angle between the V shape's two arms. An output end of the third power module A10 is connected to an input end of at least a fifth tube A30. An output end of the fifth tube A30 is disposed above ground to expel seawater. The fifth tube MO includes a number of L-shaped step sections A31 end-to-end sequentially connected in series between the fifth tube A30's input and output ends.

A number of flow guiding modules 50 includes first waterwheels 51, second waterwheels 52, hoist devices 53, motors 54, and transmission elements 55

The first waterwheels 51 are configured along the fourth tube A20. The second waterwheels 52 and the hoist devices 53 are configured along the step sections A31. The third hydro power modules A10 are respectively electrically connected to the motors 54. The motors 54 are connected to the hoist devices 53. The third power module A10 produces electricity as seawater flows through, and the electricity powers the motors 54 which in turn drive the hoist devices 53 to lift and expel seawater. The electricity also powers the motors 54 of a second assembly A. The electricity from the third hydro power modules A10 of the second assembly A is used to power at least an external equipment (not shown) or is stored in at least a battery (not shown).

Each transmission element 55 is configured between a first waterwheel 51 and a second waterwheel 52. As the first waterwheels 51 are engaged by seawater flowing through, the second waterwheels 52 are engaged as well through the transmission elements 55. The second waterwheels 52 respectively turn the hoist devices 53 to left seawater upward.

The present embodiment may include at least two assemblies A working together, where produced electricity is distributed to the motors and for external use, thereby reducing the loading of third power modules A10 of the assemblies A.

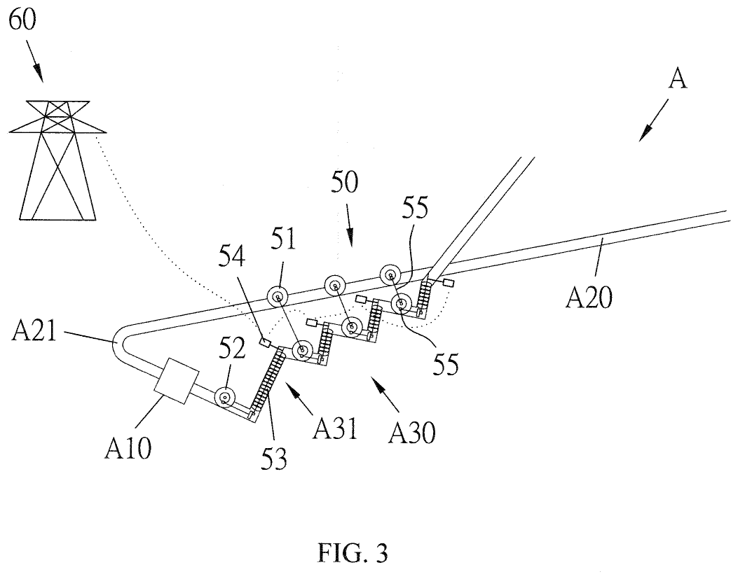

As shown in FIGS. 3 and 5, a power generation device according to a third embodiment of the present invention is similar to the previous embodiment and description to the identical parts is omitted.

The previous embodiment and the present embodiment differ in that the motors 54 are electrically connected to an external power source 60 (such as a power grid or a solar panel) and respectively connected to the hoist devices 53. The third power module A10 produces electricity as seawater flows through to power at least an external equipment 70 or to be stored in at least a battery.

By powering the motors 54 by the external power source 60, the electricity from the third power module A10 may be fully supplied to the external equipment 70, or for households, offices, or factories.

In practical application, the first tube A20 may be integrated with an embankment 80 where vortex may be prevented. However, the present invention is not limited to embankment. In addition, a mesh (not shown) may be configured at the input end of the first tube A20 that is open to seawater.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A power generation device utilizing seawater, comprising:
a first tube disposed underground having an input end below sea level to facilitate drawing seawater;
at least one first hydro power module disposed underground, where the at least one first hydro power module has an input connected to an output end of the first tube;
at least one second tube comprising a bended section having a less than 90-degree angle between the bended section's two arms, where an input end of the at least one second tube is connected to an output end of the first hydro power module;
at least one second hydro power module disposed underground, where an input end of the at least one second hydro power module is connected to an output end of the at least one second tube;
at least one third tube having an input end connected to an output end of the at least one second hydro power module and an output end disposed above ground to expel seawater, where the at least one third tube comprises a plurality of step sections end-to-end sequentially connected in series between the at least one third tube's input and output ends; and
a plurality of flow guiding modules comprising first waterwheels, second waterwheels, hoist devices, motors, and transmission elements, where the first waterwheels are configured along the first tube, the second waterwheels and the hoist devices are configured along the step sections, the at least one first hydro power modules are respectively electrically connected to the motors, and the motors are connected to the hoist devices;
wherein the at least one first hydro power module and the at least one second hydro power module produce electricity as seawater flow through; electricity from the at least one first hydro power module powers the motors which in turn drive the hoist devices to lift and expel seawater; electricity from the at least one second hydro power module is used to power at least an external equipment or is stored in at least a battery.

2. The power generation device according to claim 1, wherein each transmission element is configured between a first waterwheel and a second waterwheel; the first waterwheels are engaged by seawater flowing through; the second waterwheels are engaged as well through the transmission elements; the second waterwheels respectively turn the hoist devices to left seawater upward.

3. The power generation device according to claim 1, wherein the first tube is integrated with an embankment; and a mesh is configured at the input end of the first tube.

4. A power generation device utilizing seawater, comprising an assembly, wherein the assembly comprises:
at least one fourth tube disposed underground having an input end below sea level to facilitate drawing seawater, where the at least one fourth tube comprises a bended section having a less than 90-degree angle between the bended section's two arms;
at least one third hydro power module disposed underground, where the at least one third hydro power module has an input end connected to an output end of the at least one fourth tube;
at least one fifth tube having an input end connected to an output end of the at least one third hydro power module and an output end disposed above ground to expel seawater, where the at least one fifth tube comprises a plurality of step sections end-to-end sequentially connected in series between the at least one fifth tube's input and output ends; and
a plurality of flow guiding modules comprising first waterwheels, second waterwheels, hoist devices, motors, and transmission elements, where the first waterwheels are configured along the at least one fourth tube, the second waterwheels and the hoist devices are configured along the step sections, the at least one third hydro power modules are respectively electrically connected to the motors, and the motors are connected to the hoist devices;
the at least one third hydro power module produces electricity as seawater flow through; electricity from the at least one third hydro power module powers the motors which in turn drive the hoist devices to lift and expel seawater, and is used to power at least an external equipment or is stored in at least a battery.

5. The power generation device according to claim 4, wherein each transmission element is configured between a first waterwheel and a second waterwheel; the first waterwheels are engaged by seawater flowing through; the second waterwheels are engaged as well through the transmission elements; the second waterwheels respectively turn the hoist devices to left seawater upward.

6. The power generation device according to claim 4, wherein the first tube is integrated with an embankment; and a mesh is configured at the input end of the first tube.

7. A power generation device utilizing seawater, comprising an assembly, wherein the assembly comprises:
at least one fourth tube disposed underground having an input end below sea level to facilitate drawing seawater, where the at least one fourth tube comprises a bended section having a less than 90-degree angle between the bended section's two arms;
at least one third hydro power module disposed underground, where the at least one third hydro power module has an input end connected to an output end of the at least one fourth tube;
at least one fifth tube having an input end connected to an output end of the at least one third hydro power module and an output end disposed above ground to expel seawater, where the at least one fifth tube comprises a plurality of step sections end-to-end sequentially connected in series between the at least one fifth tube's input and output ends; and
a plurality of flow guiding modules comprising first waterwheels, second waterwheels, hoist devices, motors, and transmission elements, where the first waterwheels are configured along the at least one fourth tube, the second waterwheels and the hoist devices are configured along the step sections, the motors are electrically connected to an external power source, and the motors are connected to the hoist devices;
the at least one third hydro power module produces electricity as seawater flow through; electricity from the at least one third hydro power module is used to power at least an external equipment or is stored in at least a battery.

8. The power generation device according to claim 7, wherein each transmission element is configured between a first waterwheel and a second waterwheel; the first waterwheels are engaged by seawater flowing through; the second waterwheels are engaged as well through the transmission elements; the second waterwheels respectively turn the hoist devices to left seawater upward.

9. The power generation device according to claim 7, wherein the first tube is integrated with an embankment; and a mesh is configured at the input end of the first tube.
